(19) United States
(12) Patent Application Publication
(10) Pub. No.: US 2026/0116749 A1
(43) Pub. Date: Apr. 30, 2026

(54) Doped Barium Niobates for Thermochemical Water Splitting to Produce Hydrogen

(71) Applicant: UNM RAINFOREST INNOVATIONS, Albuquerque, NM (US)

(72) Inventors: Kannan RAMAIYAN, Albuquerque, NM (US); Fernando GARZON, Santa Fe, NM (US)

(73) Assignee: UNM RAINFOREST INNOVATIONS, Albuquerque, NM (US)

(21) Appl. No.: 19/372,491

(22) Filed: Oct. 29, 2025

Related U.S. Application Data
(60) Provisional application No. 63/714,505, filed on Oct. 31, 2024.

(51) Int. Cl. C01B 3/06; B01J 23/00; B01J 23/20; B01J 23/847

(52) U.S. Cl. CPC C01B 3/063; B01J 23/002; B01J 23/20; B01J 23/8474; B01J 2523/23; B01J 2523/25; B01J 2523/36; B01J 2523/3718; B01J 2523/3787; B01J 2523/56; B01J 2523/845; B01J 2523/847

(57) ABSTRACT

A hydrogen production method includes the heating of a catalyst in a furnace under reducing conditions to a first temperature, exposing the catalyst to water at a second temperature, and forming oxygen and hydrogen by thermolysis of the water, where the catalyst may include a barium niobate-based perovskite structure having the chemical formula of Ba₁₋ₓ(AE)ₓNb_{1-(y+z)}(AE)_{y}M_{z}O_{3-δ} wherein AE is an alkaline earth (AE) element and M is a metal. M may include a transition metal or a rare earth metal. AE may include Mg, Ca, Sr, or a combination thereof. AE may alternatively include K, Rb, Cs or a combination thereof. M may include Fe, Co, Ni, Y, Yb, W, Ta, Pr, or a combination thereof. M may include Sc, Ti, V, Cr, Mn, Cu, Zn, Zr, Mo, La, Ce, Sm, Gd, W or a combination thereof.

### REFERENCE TO RELATED APPLICATIONS (PROVISIONAL)

This application claims the benefit of U.S. Provisional Patent Application No. 63/714,505, filed on Oct. 31, 2024, which is hereby incorporated by reference in its entirety.

### TECHNICAL FIELD

The present teachings relate generally to niobate-based materials and, more particularly, to the use of niobate-based materials in the production of hydrogen.

### BACKGROUND

Hydrogen is increasingly recognized as a central vector in the transition toward a carbon-neutral energy economy. Among the many routes for sustainable hydrogen generation, thermochemical water splitting (TWS) is a promising pathway for direct solar-to-fuel conversion and effective utilization of nuclear waste heat. By coupling concentrated solar power (CSP) or high-temperature nuclear heat with redox-active materials, TWS offers the potential for highly efficient, scalable, and emission-free hydrogen production.

The fundamental idea behind TWS is to exploit high-temperature redox cycles that split water into hydrogen and oxygen without the need for electricity. Materials with ability to exchange its lattice oxygen and regain it under reducing and oxidizing conditions respectively are essential for this application.

Therefore, it is desirable to develop and utilize materials that can participate in efficient and effective reactions and pathways for improved hydrogen generation reactions.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A hydrogen production method is disclosed. The hydrogen production method includes heating a catalyst in a furnace or reactor under inert or reducing conditions to a first temperature. The method also includes exposing the catalyst to water; and forming oxygen and hydrogen by thermolysis of the water, and where the catalyst may include a barium niobate-based perovskite structure having the chemical formula of Ba₁₋ₓ(AE)ₓNb_{1-(y+z)}(AE)_{y}M_{z}O_{3-δ} wherein AE is an alkaline earth (AE) element and M is a metal. Implementations of the hydrogen production method can include where M may include a transition metal or a rare earth metal. AE may include Mg. Ca, Sr, or a combination thereof. AE may include K, Rb, Cs or a combination thereof. M may include Fe, Co, Ni, Y, Yb, W, Ta, Pr, or a combination thereof. M may include Sc. Ti, V, Cr, Mn, Cu, Zn, Zr, Mo, La, Ce, Sm, Gd, W or a combination thereof. X is from 0 to about 0.60. Y is from 0 to about 0.80. Z is from 0 to about 0.80. The hydrogen production method may include lowering the furnace to a second temperature prior to exposing the catalyst to water. The second temperature is lower than the first temperature. The second temperature is from about 600° C. to about 1100° C. The first temperature is from about 800° C. to about 1500° C. The barium niobate-based perovskite structure has the chemical formula of BaCa_{0.33}Nb_{0.67-x}MₓO_{3-δ} and BaMg_{0.33}Nb_{0.67-x}MₓO_{3-δ} where M is one or more of Fe, Co, Ni, Y, Yb, or Pr and M is from about x=0 to about x=0.50.

Another hydrogen production method. The hydrogen production method includes heating a catalyst in a furnace or reactor under inert or reducing conditions to a first temperature. The method also includes lowering the furnace to a second temperature that is lower than the first temperature. The method also includes exposing the catalyst to water. The method also includes forming oxygen and hydrogen by thermolysis of the water; and where the catalyst may include a barium niobate-based perovskite structure having the chemical formula of Ba₁₋ₓ(AE)ₓNb_{1-(y+z)}(AE)_{y}M_{z}O_{3-δ} wherein AE is an alkaline earth (AE) element and M is a metal. Implementations of the hydrogen production method can include where the catalyst may include a cerium-based dopant. The first temperature is from about 800° C. to about 1500° C., and the second temperature is from about 600° C. to about 1100° C. AE may include Mg. Ca, Sr, Na, K, Rb, Cs, or a combination thereof. M may include Sc, Ti, V, Cr, Mn, Fe, Co, Ni, Cu, Zn, Y, Zr, Mo, La, Ce, Pr, Sm, Gd, Yb, Ta, W or a combination thereof.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIGS. 1A-ID are plots depicting thermogravimetric analysis under various gas environments with varying catalysts, in accordance with the present disclosure.

FIG. 2 is a plot depicting temperature cycling of 20% yttrium doped barium calcium niobate (BCNY20) in the temperature range of 400 to 900° C. in air, showing a reversible oxygen exchange of 0.5% between 500° C.-800° C., in accordance with the present disclosure.

FIGS. 3A and 3B depict plots of temperature cycling between 1000° C. and 1200° C. under reducing and oxidizing conditions for a crushed alumina crucible and an exemplary catalyst, respectively, in accordance with the present disclosure.

FIGS. 4A and 4B depict plots of temperature cycling between 1000° C. and 1200° C. under reducing and oxidizing condition obtained for BCNF33 and CeO_{2(1-δ)}, respectively, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

Thermochemical water splitting to produce hydrogen involves heating metal oxides to high temperatures under reducing conditions where it loses lattice oxygen followed by exposure to steam that results water splitting into hydrogen and oxygen. Materials with ability to exchange its lattice oxygen and regain it under reducing and oxidizing conditions respectively are essential for this application. Transition metal doped barium calcium niobates and barium magnesium niobates have shown remarkable ability to exchange its lattice oxygen under reducing conditions and regain it, which is ideally suited for this application. The ability of niobium to switch its oxidation state between 4+ and 5+ and transition metal dopants ability to exsolve and reinsert into the crystal lattice are two key parameters that are central to the success of this material in this application. The emerging need to produce hydrogen from non-carbon sources to decarbonize the hydrogen economy indicates a significant potential for this material to enter the commercial market and establishes it as a viable candidate for large-scale deployment.

Water splitting processes can be used to produce hydrogen, which follows a thermochemical process using a metal oxide. The metal oxide is heated under a reducing atmosphere to a high temperature. The metal oxide loses some of its oxygen then the temperature is brought lower, then exposed to water vapor. In exemplary examples of a hydrogen production method including the heating of a catalyst in a furnace or reactor under inert or reducing conditions to a first temperature is used. The method also includes exposing the catalyst to water, and forming oxygen and hydrogen by thermolysis of the water, and where the catalyst may include a barium niobate-based perovskite structure having the chemical formula of Ba₁₋ₓ(AE)ₓNb_{1-(y+z)}(AE)_{y}M_{z}O_{3-δ} wherein AE is an alkaline earth (AE) element and M is a metal. In examples, M may include a transition metal or a rare earth metal. AE may include Mg, Ca, Sr, or a combination thereof. AE may alternatively include K, Rb, Cs or a combination thereof. M may include Fe, Co, Ni, Y, Yb, W, Ta, Pr, or a combination thereof. M may include Sc, Ti, V, Cr, Mn, Cu, Zn, Zr, Mo, La, Ce, Sm, Gd, W or a combination thereof. X can be from 0 to about 0.60. Y can be from 0 to about 0.80. Z can be from 0 to about 0.80. The hydrogen production method may include lowering the furnace to a second temperature prior to exposing the catalyst to water. The second temperature is lower than the first temperature and can be from about 600° C. to about 1100° C. The first temperature can be from about 800° C. to about 1500° C. The barium niobate-based perovskite structure can also have the chemical formula of BaCa_{0.33}Nb_{0.67-x}MₓO_{3-δ} and BaMg_{0.33}Nb_{0.67-x}MₓO_{3-δ} where M is one or more of Fe, Co, Ni, Y, Yb, or Pr and M is from about x=0 to about x=0.60.

The oxide type is used in the present teachings. This oxide-based material re-oxidizes by capturing the oxygen from the water and releases the hydrogen. In examples, BCNF33 TGA analysis of catalysts of the present disclosure shows that weight loss around 900° C., can amount to about 0.8% weight loss in a reducing gas atmosphere. In the water splitting reaction, the catalysts can be exposed to temperatures up to 1400° C. in reducing atmosphere, and would lose much more oxygen in these conditions. When the reaction is cooled to 1000° C., or lower, in the presence of water, it would produce a larger quantity of hydrogen. The data shown and described herein represents the potential of this material in this application of water splitting. The first temperature can be from between about 800° C. to about 1000° C., or from about 900° C. to about 1100° C., or from about 1000° C. to about 1200° C., or from about 1200° C. to about 1500° C. or any combinations of these ranges. The second temperature can be from about 600° C. to about 800° C., or from about 800° C. to about 1000° C., or from about 1000° C. to about 1200° C., or any combinations of these ranges. The second temperature will always be lower than the first temperature. The weight loss in the catalyst can be from as low as 0.5% to as high as 5% in different process conditions as described herein.

In examples, transition metal doped barium calcium niobates and barium magnesium niobates have shown remarkable ability to exchange its lattice oxygen under reducing conditions and regain it, which is ideally suited for this application of water splitting. The ability of niobium to switch its oxidation state between 4⁺ and 5⁺ and transition metal dopants ability to change their oxidation states provide this class of materials with a unique ability to exchange significantly high oxygen without going through noticeable change in its crystal structure. The ability of transition metal dopants to exsolve and reinsert into the crystal lattice is an added advantage under extremely reducing conditions. The emerging need to produce hydrogen from non-carbon sources to decarbonize the hydrogen economy indicates significant potential for this material to be in commercial market space and may lead to efficient production of hydrogen via water splitting. It also provides a means to convert any nuclear waste heat to a value added fuel while also providing a viable means to store the solar energy.

Water splitting processes can be used to produce hydrogen, which follows a thermochemical process using a metal oxide. The metal oxide is heated under a reducing atmosphere to a first, high temperature. The metal oxide loses some of its oxygen then the temperature is brought to a lower, second temperature, then exposed to water vapor and oxygen is regained.

Two-step reaction cycles are naturally the simplest multistep thermochemical water-splitting methods and may be classified into one of the following three types of reactions: The process typically proceeds through a two-step cycle:

### (i) Oxide Type

### 1. High-Temperature Reduction Step (Oxygen Release):

A metal oxide (MOₓ) is thermally reduced at 1200-1600° C., generating oxygen vacancies and releasing O₂.

$${M O}_{x} \to {M O}_{x - δ} + \frac{δ}{2} {O}_{2}$$

### 2. Low-Temperature Oxidation Step (Hydrogen Generation):

The reduced oxide reacts with water vapor at 800-1100° C., replenishing its oxygen content while releasing H₂.

$${M O}_{x - δ} + δ {H}_{2} O \to {M O}_{x} + {δ H}_{2}$$

### (ii) Hydride Type

### 1. High-Temperature Reduction Step (Hydrogen Release):

A metal hydride (MOₓ) is thermally reduced at 1200° C.-1600° C., releasing H₂ from its crystal lattices such as interstitial places.

$${M H}_{2} \to M + {H}_{2}$$

### 2. Low-Temperature Oxidation Step (Oxygen Generation):

The hydrogen striped metal hydride reacts with water vapor at 800° C.-1100° C., replenishing its hydrogen content while releasing O₂.

$$M + {H}_{2} O \to {M H}_{2} + {\frac{1}{2} O}_{2}$$

(iii) Hydroxide Type

### 1. High-Temperature Reduction Step (Oxygen Release):

A metal hydroxide (M(OH)ₓ) type is thermally reduced at 500° C.-600° C., generating oxygen vacancies and releasing O₂.

$${M ( OH )}_{2} \to M O + {H}_{2} O$$

This may undergo further oxygen loss at higher temperatures such as 1000° C.-1500° C.

$$M O \to M + \frac{1}{2} {O}_{2}$$

### 2. Low-Temperature Oxidation Step (Hydrogen Generation):

The reduced metal hydroxide and metal reacts with water vapor at 800° C.-1100° C., replenishing its oxygen content while releasing H₂.

$$2 {M ( OH )}_{x - 1} + 2 {H}_{2} O \to 2 M OH + {H}_{2}$$

$$M + {H}_{2} O \to {M ( OH )}_{2} + {H}_{2}$$

These approaches decouple O₂ and H₂ production in time, eliminating the risk of explosive gas mixtures and enabling cyclic operation. Efficiency is dictated by the material's ability to undergo reversible non-stoichiometry with favorable thermodynamics and kinetics.

The oxide type is used in the present teaching using a unique perovskite type metal oxide. The perovskite material cycles reversibly between oxidized state and reduced state by capturing the oxygen from water and releases the hydrogen. The perovskite used in this study can be regular, or single perovskite, double perovskite, or triple perovskite, depending on the choice of dopants.

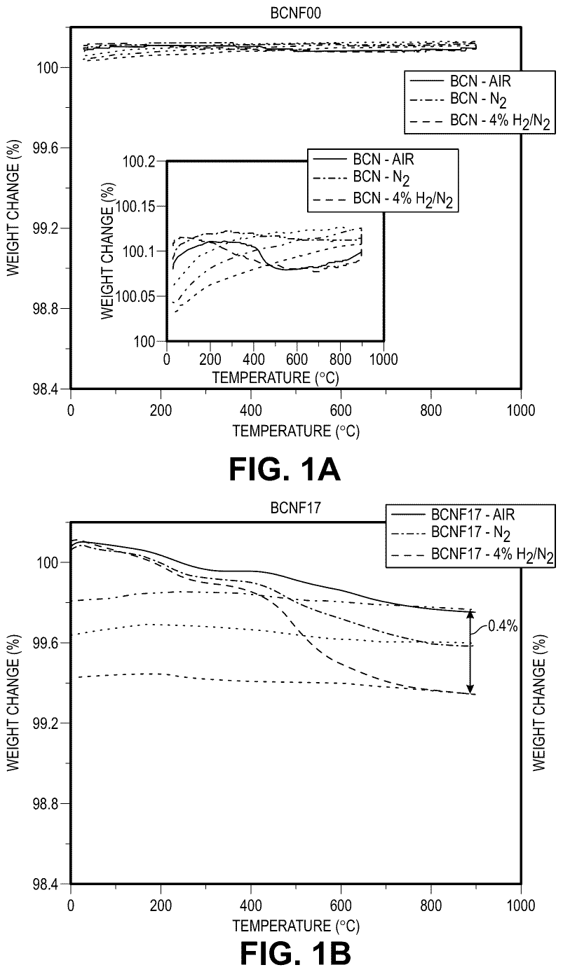

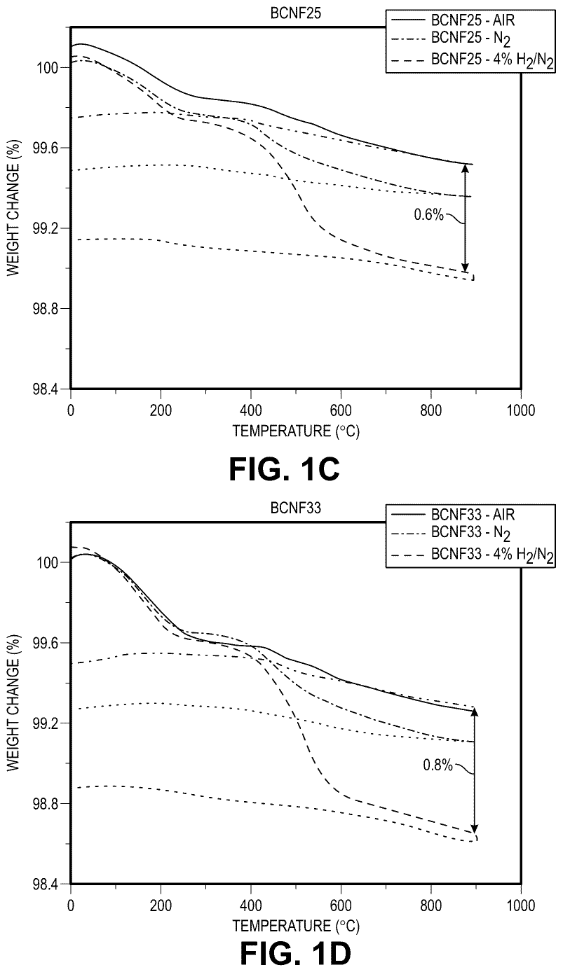

FIGS. 1A-ID are plots depicting thermogravimetric analysis under various gas environments with varying catalysts, in accordance with the present disclosure. The iron (Fe)-doped barium calcium niobate has shown highly promising redox-active material for thermochemical water splitting. The unique crystal structure and mixed B-site cation chemistry of the iron (Fe)-doped barium calcium niobate can enable enhanced oxygen exchangeability, which is critical for cyclic hydrogen production. Unlike conventional materials such as ceria, where the redox process relies on a single cation (Ce⁴⁺/Ce³⁺), this perovskite leverages the dual redox flexibility of niobium (Nb) and iron (Fe). Both elements can undergo reversible changes in oxidation state, thereby increasing the extent of non-stoichiometry while maintaining structural stability. As the iron content of the catalyst is increased from 0 to 33 the amount of weight loss increases with a change from air to nitrogen to hydrogen/nitrogen environments. Thermogravimetric analysis under the aforementioned various gas environments exhibit up to 0.8% excess loss in oxygen at 900° C. when the environment is switched from air to 4% H₂ of BCNF33. BCNF00 with no Fe doping show no change in weight loss behavior while increasing Fe doping leads to increased weight loss under reducing environments. Iron addition leads to weight loss proportional to iron loading and higher weight loss under reducing conditions, while the excess weight loss under reducing conditions can be indicative of a loss of lattice oxygen. In examples, compounds notated as BCNF can include calcium-doped, iron-doped, or yttrium-doped barium niobate in compositions such as BaCa_{0.33}Nb_{0.67}O_{3-δ}—(BCN), BaCa_{0.33}Nb_{0.50}Fe_{0.17}O_{3-δ}—(BCNF17), BaCa_{0.33}Nb_{0.42}Fe_{0.25}O_{3-δ}—(BCNF25), BaCa_{0.33}Nb_{0.34}Fe_{0.33}O_{3-δ}—(BCNF33), BaCa_{0.33}Nb_{0.54}Y_{0.13}O_{3-δ}—(BCNY13), BaCa_{0.33}Nb_{0.34}Fe_{0.2}Y_{0.13}O_{3-δ}—(BCNFY), BaCa_{0.33}Nb_{0.47}Y_{0.20}O_{3-δ}—(BCNY20), BaCa_{0.33}Nb_{0.42}Y_{0.25}O_{3-δ}—(BCNY25), BaCa_{0.33}Nb_{0.34}Y_{0.33}O_{3-δ}—(BCNY33), or combinations thereof.

In examples, Fe doped BCNs show electronic conductivity and behave like resistors while Y doped BCNs show ionic conductivity. Both electronic or ionic conductivity can indicate the ability of these materials to exchange oxygen as well. The materials with higher ionic or electronic conductivity tend to lose more hydrogen than undoped electrically insulating compounds.

In other examples, cerium compounds can be used as dopants to niobates or as co-catalysts in combination with niobates to improve the efficiency of the thermochemical water splitting reaction. Illustrative examples of appropriate cerium compounds can include BaCa_{0.33}Nb_{0.50}Ce_{0.17}O_{3-δ}—(BCNCe17), BaCa_{0.33}Nb_{0.42}Ce_{0.25}O_{3-δ}—(BCNCe25), BaCa_{0.33}Nb_{0.34}Ce_{0.33}O_{3-δ}—(BCNCe33). Illustrative compositions of catalysts including cerium-doped materials where Ce can be from about 0.0 to about 0.8.

The thermogravimetric studies demonstrate excellent ability of oxygen excretion at 900° C. when the environment is switched from air to 4% H₂ on BCNF perovskites. Oxygen excretion increases with increasing Fe doping, and a maximum of 0.8% oxygen loss is observed for the 33% Fe doped BCNF 33 when the operating environment is switched from air to 4% H₂. The TGA data also show that the oxygen exertion starts to occur at really low temperatures of about 500° C. (as shown in FIGS. 1A-ID).

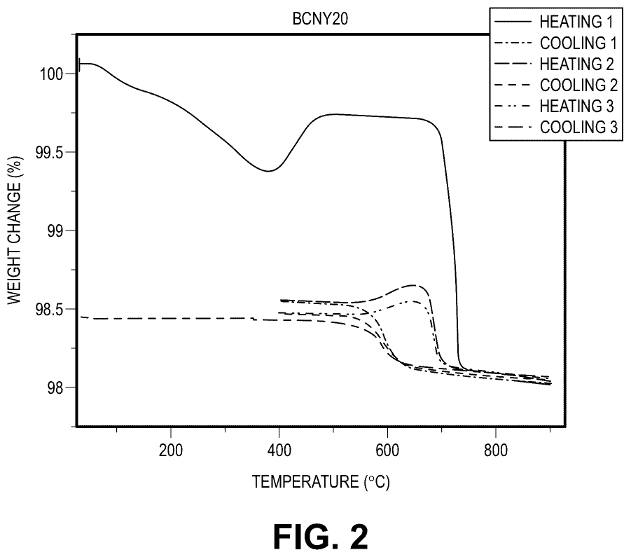

FIG. 2 is a plot depicting temperature cycling of 20% yttrium doped barium calcium niobate (BCNY20) in the temperature range of 400° C. to 900° C. in air, showing a reversible oxygen exchange of 0.5% between 500° C. and 800° C., in accordance with the present disclosure. Temperature cycling between 400° C. to 900° C. in air reveal a reversible oxygen exchange of ˜0.5% between 50° and 800° C. in yttrium doped barium calcium niobate (BCNY20) further iterating the significance of doping and further room for improvement in this type of material, as shown in FIG. 2.

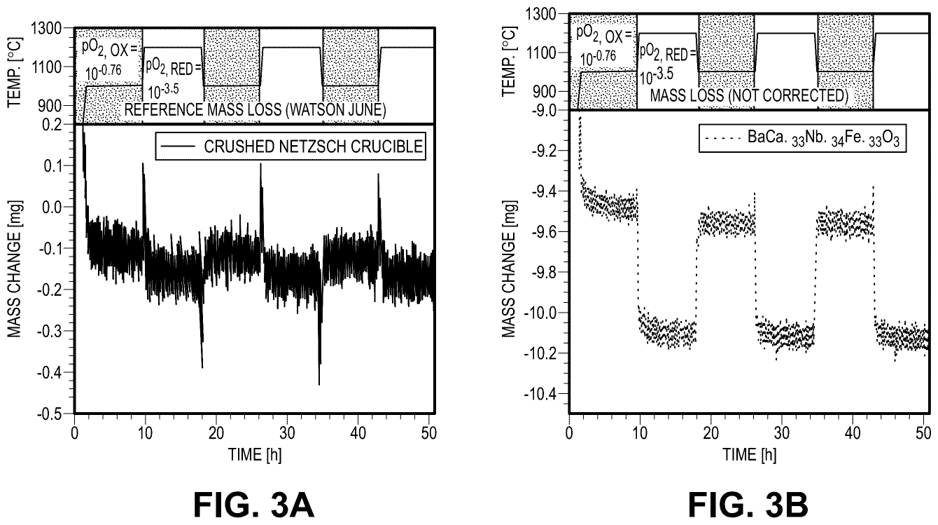

FIGS. 3A and 3B depict plots of temperature cycling between 1000° C. and 1200° C. under reducing and oxidizing conditions for a crushed alumina crucible and an exemplary catalyst, respectively, in accordance with the present disclosure. Temperature cycling in simulated thermochemical water splitting conditions using 33% Fe doped BCNF33 between 1000° C. and 1200° C. under reducing and oxidizing conditions show remarkable cycling stability at conditions directly relevant to solar-driven thermochemical cycles, as shown in FIGS. 3A and 3B. The material exhibits consistent redox cycling without significant degradation, suggesting high durability and efficiency for long-term operation. This combination of enhanced oxygen exchange capacity, robust structural integrity, and favorable redox thermodynamics positions Fe-doped barium calcium niobate as a next-generation candidate for scalable thermochemical hydrogen production. The alumina crucible alone did not show any significant weight change confirming all the weight variations observed are due to BCNF33. The material can be cycled for hundreds to thousands of times and due to its high conductivity at these temperatures, the material is expected to fully retain the performance.

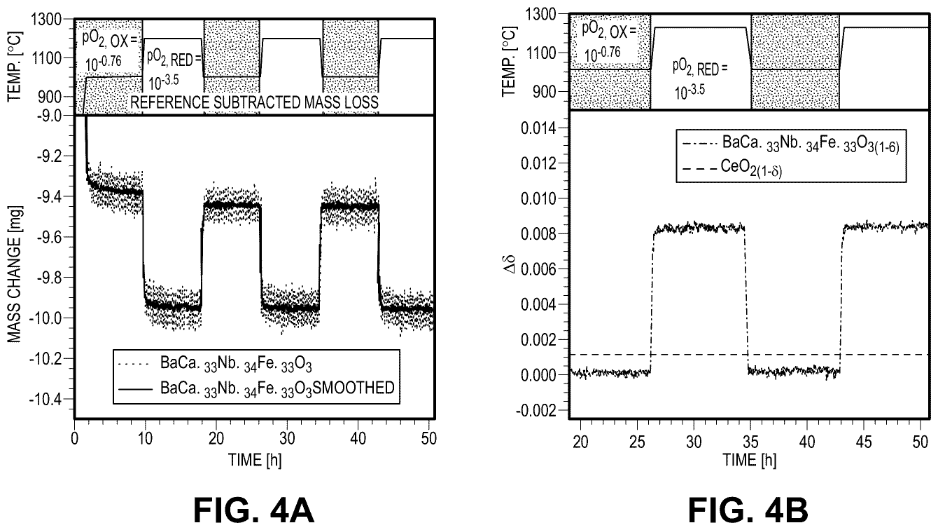

FIGS. 4A and 4B depict plots of temperature cycling between 1000° C. and 1200° C. under reducing and oxidizing condition obtained for BCNF33 and CeO_{2(1-δ)}, respectively, in accordance with the present disclosure. For comparison, the data obtained for CeO₂ under similar conditions is given in FIGS. 4A and 4B along with that of BCNF33. The weight variations in CeO₂ under these conditions are negligible compared to BCNF33 highlighting the unique properties of this material and its fitness for this application. CeO₂ required temperatures higher than 1400° C. to act as a candidate for thermochemical water splitting. BCNF perovskites can significantly reduce the required temperature thereby increasing the efficiency of the process.

BCNF33 Catalyst material properties—Most materials which have been studied in the past, if they are heated to high enough temperatures such that they give off oxygen, but lose their crystal structure, which does not reform at lower temperatures, or the particle size changes, which is not advantageous for a continuous processes such as water splitting. BCNF33 Catalyst material properties do not undergo a large structural change of the material when cycled between very reducing and very oxidizing conditions or high and low temperature ranges. That is what makes this family of catalyst materials advantageous for these catalytic applications. In the reversible reactions between oxidation and reduction, it maintains its composition and crystal structure. Additional information is detailed in U.S. patent application Ser. No. 18/663,018, filed May 13, 2024, which is hereby incorporated herein by reference in its entirety.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including.” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A hydrogen production method, comprising:
heating a catalyst in a furnace or reactor under inert or reducing conditions to a first temperature;
exposing the catalyst to water; and
forming oxygen and hydrogen by thermolysis of the water; and wherein,
the catalyst comprises a barium niobate-based perovskite structure having the chemical formula of Ba₁₋ₓ(AE)ₓNb_{1-(y+z)}(AE)_{y}M_{z}O_{3-δ} wherein AE is an alkaline earth (AE) element and M is a metal.

2. The hydrogen production method of claim 1, wherein M comprises a transition metal or a rare earth metal.

3. The hydrogen production method of claim 1, wherein Ae comprises Mg, Ca, Sr, or a combination thereof.

4. The hydrogen production method of claim 1, wherein AE comprises K, Rb, Cs or a combination thereof.

5. The hydrogen production method of claim 1, wherein M comprises Fe, Co, Ni, Y, Yb, W, Ta, Pr, or a combination thereof.

6. The hydrogen production method of claim 1, wherein M comprises Sc, Ti, V, Cr, Mn, Cu, Zn, Zr, Mo, La, Ce, Sm, Gd, W or a combination thereof.

7. The hydrogen production method of claim 1, wherein x is from 0 to about 0.60.

8. The hydrogen production method of claim 1, wherein y is from 0 to about 0.80.

9. The hydrogen production method of claim 1, wherein z is from 0 to about 0.80.

10. The hydrogen production method of claim 1, further comprising lowering the furnace to a second temperature prior to exposing the catalyst to water.

11. The hydrogen production method of claim 10, wherein the second temperature is lower than the first temperature.

12. The hydrogen production method of claim 1, wherein the first temperature is from about 800° C. to about 1500° C.

13. The hydrogen production method of claim 10, wherein the second temperature is from about 600° C. to about 1100° C.

14. The hydrogen production method of claim 1, wherein the perovskite can be a single perovskite, double perovskite or triple perovskite.

15. The hydrogen production method of claim 1, wherein the barium niobate-based perovskite structure has the chemical formula of BaCa_{0.33}Nb_{0.67-x}MₓO_{3-δ} and BaMg_{0.33}Nb_{0.67-x}MₓO_{3-δ} where M is one or more of Fe, Co, Ni, Y, Yb, or Pr and M is from about x=0 to about x=0.50.

16. A hydrogen production method, comprising:
heating a catalyst in a furnace or reactor under inert or reducing conditions to a first temperature;
lowering the furnace to a second temperature that is lower than the first temperature;
exposing the catalyst to water; and
forming oxygen and hydrogen by thermolysis of the water; and wherein,
the catalyst comprises a barium niobate-based perovskite structure having the chemical formula of Ba₁₋ₓ(AE)ₓNb_{1-(y+z)}(AE)_{y}M_{z}O_{3-δ} wherein Ae is an alkaline earth (Ae) element and M is a metal.

17. The hydrogen production method of claim 16, wherein the catalyst further comprises a cerium-based dopant.

18. The hydrogen production method of claim 16, wherein:
the first temperature is from about 800° C. to about 1500° C.; and
the second temperature is from about 600° C. to about 1100° C.

19. The hydrogen production method of claim 16, wherein AE comprises Mg, Ca, Sr, Na, K, Rb, Cs or a combination thereof.

20. The hydrogen production method of claim 16, wherein M comprises Sc, Ti, V, Cr, Mn, Fe, Co, Ni, Cu, Zn, Y, Zr, Mo, La, Ce, Pr, Sm, Gd, Yb, Ta, W or a combination thereof.
